(19) United States
(12) Patent Application Publication
(10) Pub. No.: US 2022/0195239 A1
(43) Pub. Date: Jun. 23, 2022

(54) MEKO-FREE SILICONE COATING

(71) Applicant: SWIMC LLC, Cleveland, OH (US)

(72) Inventors: Melody N. GIBSON, Reminderville, OH (US); Jennifer M. KRISTY, Cleveland, OH (US); Liqun SUN, Glenwillow, OH (US)

(21) Appl. No.: 17/558,649

(22) Filed: Dec. 22, 2021

Related U.S. Application Data
(60) Provisional application No. 63/199,372, filed on Dec. 22, 2020.

(51) Int. Cl. C09D 183/06; C09D 7/63; C09D 7/61; C08G 77/16; C08K 3/26; C08K 3/22; C08K 3/36; C08L 91/00; C08K 5/5425; C08K 5/544

(52) U.S. Cl. CPC C09D 183/06; C09D 7/63; C09D 7/61; C08G 77/16; C08K 3/26; C08K 3/22; C08L 2205/025; C08L 91/00; C08K 5/5425; C08K 5/544; C08G 2150/00; C08K 2003/265; C08K 2003/2241; C08K 3/36

(57) ABSTRACT

A coating is disclosed that provides an alternative to Methyl Ethyl Ketoxime-generating silicone coatings. The compositions comprises an oxime-free silicone coating that is more environmentally safe and safe for the users. MEKO-free silicone coating compositions and methods of making/using such products are also disclosed.

This application claims priority to and the benefit of U.S. Provisional Application 63/199,372, titled “MEKO-FREE SILICONE COATING,” filed on Dec. 22, 2020, the disclosure and contents of which are incorporated herein by reference in its entirety.

### FIELD OF INVENTION

The present disclosure relates to a composition that is a non-methyl ethyl ketoxime generating composition. In particular, the present disclosure relates to silicone coating compositions that do not release methyl ethyl ketoxime as a byproduct.

### BACKGROUND

Traditionally, the paint and coating industries have used a slow evaporating solvent called Methyl Ethyl Ketoxime (“MEKO”) to act as an anti-skinning agent, which need to be carefully removed prior to use. However, there exist environmental concerns regarding the use of MEKO additives; for example, research carried out for the European Union Registration, Evaluation, Authorization and Restriction of Chemicals (“REACH”) has resulted in MEKO possibly being considered a carcinogen with some authorities proposing that it be classified as a Category 1B Carcinogen.

### SUMMARY

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

The present technology provides a coating composition that does not incorporate the use of MEKO or yield MEKO as a byproduct during formation of the coating. The present compositions employ materials that that release methanol or ethanol as the leaving group instead of methyethylketoxime, which is considered a carcinogen. This inventive non-MEKO releasing composition could, among other uses, be applied as a silicone coating as an alternate option to oxime releasing coatings, paints, or sealants.

In accordance with an example embodiment, there is disclosed herein a coating comprising one or more of a polydimethylsiloxane polymer, one or more of an adhesion promoter, one or more of a crosslinker, titanium dioxide, and a catalyst.

In particular embodiments, the composition further comprises silicon dioxide, calcium carbonate, nepheline syenite, and/or mineral oil.

In another aspect, there are also disclosed herein methods of providing a coating in the form of a coating composition comprising providing at least a first surface to be coated, delivering a coating composition to said at least a first surface to be coated, said coating composition comprising one or more of a polydimethylsiloxane polymer, one or more of an adhesion promoter, one or more of a crosslinker, titanium dioxide, and a catalyst. Substrates for applying the disclosed coating composition may include, but are not limited to, exterior and/or interior walls, floors, roofs walkways, and vehicle surfaces.

In a first embodiment, provided is a coating composition comprising: a polydimethylsiloxane polymer; an adhesion promoter; a crosslinker; titanium dioxide; and a catalyst, wherein the composition does not release methyl ethyl ketoxime as a byproduct upon curing.

In a second embodiment, provided is a coating composition according to the first embodiment, wherein the crosslinker is selected from an alkoxy crosslinker, an oligomeric siloxane, an oxime crosslinker, or a combination of two or more thereof.

In a third embodiment, provided is a coating composition according to the first embodiment, wherein the crosslinker comprises an oligomeric siloxane comprising vinyl and methoxy groups.

In a fourth embodiment, provided is a coating composition according to the second embodiment, wherein the crosslinker comprises an oxime crosslinker selected from the group of Ethyl-tris(acetonoximo)silane, Methyl-tris(methylpropylketoximo)silane, Methyltris(ketoximo) silane, Tris(methylpropylketoximo)vinylsilane, Vinylmethoxy-di(acetonooximo)silane, Vinyl-tri s(methylpropylketoximo)silane, or a combination of two or more thereof.

In a fifth embodiment, provided is a coating composition according to the second embodiment, wherein the crosslinker comprises an alkoxy crosslinker selected from the group of Vinyltrimethyoxysilane, Vinyltriethyoxysilane, Methyltrimethoxysilane, Methyltriethoxysilane, or a combination of two or more thereof.

In a sixth embodiment, provided is a coating composition according to any of the first through the fifth embodiments, wherein the crosslinker is present in an amount of from about 5 wt. % to about 10 wt. % based on the total weight of the coating composition.

In a seventh embodiment, provided is a coating composition according to any of the first through sixth embodiments, the polydimethylsiloxane polymer comprises terminated curable silanol functionality.

In an eighth embodiment, provided is a coating composition according to the seventh embodiment, wherein the polydimethylsiloxane polymer comprises a first silanol terminal functional polydimethylsiloxane having a viscosity of from about 500 cps to about 1000 cps, and a second silanol terminal functional polydimethyl siloxane having a viscosity of from about 14000 cps to about 20000 cps.

In a ninth embodiment, provided is a coating composition according to the eighth embodiment, wherein the first silanol terminal functional polydimethylsiloxane is present in an amount of from about 20 wt. % to about 60 wt. %, and the second silanol terminal functional polydimethylsiloxane is present in an amount of from about 20 wt. % to about 60 wt. % based on the total weight of the coating composition.

In a tenth embodiment, provided is a coating composition according to any of the first through the ninth embodiment, wherein the adhesion promoter is selected from 3-aminopropyltrimethoxysilane, 3-aminopropyldimethoxymethylsilane, N-(2-aminoethyl)-3-aminopropyltrimethoxysilane, N-(2-aminoethyl)-3-aminopropyldimethoxymethylsilane, N-(2-aminoethyl)-N′-[3-(trimethoxysilyl)propyl]ethylenediamine N-(n-butyl)-3-aminopropyltrimethoxysilane, N(beta-aminoethyl) gamma-aminopropyltrimethoxy-silane, or an analogue of such silanes wherein at least on ethoxy group is present in the place of a methoxy group.

In an eleventh embodiment, provided is a coating composition according to any of the first through the tenth embodiments, wherein the adhesion promoter is selected from (i)N-(n-butyl)-3-aminopropyltrimethoxysilane, and N(beta-aminoethyl) gamma-aminopropyltrimethoxy-silane, or (ii)N-(n-butyl)-3-aminopropyltrimethoxysilane, and from 3-aminopropyltrimethoxysilane.

In a twelfth embodiment, provided is a coating composition according to any of the first through the eleventh second embodiments, wherein the adhesion promoter is present in an amount of from about 0.1 wt. % to about 5 wt. % based on the total weight of the coating composition.

In a thirteenth embodiment, provided is a coating composition according to any of the first through the twelfth embodiments, further comprising silicon dioxide.

In a fourteenth embodiment, provided is a coating composition according the thirteenth embodiment, wherein the silicon dioxide comprises a hydrophobic silica.

In a fifteenth embodiment, provided is a coating composition according to any of the first through the fourteenth embodiments, further comprising calcium carbonate.

In a sixteenth embodiment, provided is a coating composition according to the fifteenth embodiment, wherein the titanium dioxide is present in an amount of from about 2 wt. % to about 12 wt. %, and the calcium carbonate is present in an amount of from about 5 wt. % to about 12 wt. % based on the total weight of the composition.

In a seventeenth embodiment, provided is a coating composition according to the sixteenth embodiment, wherein the total amount of titanium dioxide and calcium carbonate combined is from about 10 wt. % to about 20 wt. % based on the total weight of the composition.

In an eighteenth embodiment, provided is a coating composition according to any of the first through the seventeenth embodiments, further comprising nepheline syenite.

In a nineteenth embodiment, provided is a coating composition according to any of the first through the eighteenth embodiments, further comprising mineral oil.

In a twentieth embodiment, provided is a method of providing a coating in the form of a coating composition comprising:

providing at least a first surface to be coated;
delivering a coating composition according to any of the first through the nineteenth embodiments to said at least a first surface to be coated.

The following description and the drawings disclose various illustrative aspects. Some improvements and novel aspects may be expressly identified, while others may be apparent from the description and drawings.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

This description provides examples not intended to limit the scope of the appended claims. The Figures generally indicate the features of the examples, where it is understood and appreciated that like reference numerals are used to refer to like elements. As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Where ranges are described for a component or material, numerical values of the respective ranges can be combined to form new and non-specified ranges.

Provided is a silicone based coating composition. The composition comprises one a siloxane polymer; an adhesion promoter; a crosslinker; titanium dioxide; and a catalyst. The crosslinker employed in the present compositions is free of methyl ethyl ketoxime and does not form methyl ethyl ketoxime as a byproduct during curing of the composition.

Siloxane Polymer

The siloxane polymer is generally not limited and can be selected as desired for a particular purpose or intended application. In embodiments, the siloxane polymer is a polydimethylsiloxane polymer. The polydimethylsiloxane polymer can be functionalized as desired. In embodiments, the polydimethyl siloxane is a hydroxy terminated polydimethylsiloxane.

In one embodiment of the present invention the siloxane polymer is a polysiloxane containing polymer containing at least two hydroxyl or hydrolysable groups, preferably terminal hydroxyl or hydrolysable groups. In one embodiment, the siloxane polymer can for example have the general formula:

X¹-A-X² (1)

where X¹ and X² are independently selected from silicon containing groups which contain hydroxyl or hydrolysable substituents and A represents a polymer chain. Examples of X¹ or X² groups incorporating hydroxyl and/or hydrolysable substituents include groups terminating as described below:
—Si(OH)₃, (R¹)Si(OH)₂, (R¹)₂SiOH, (R¹)Si(OR²)₂, Si(OR²)₃, (R¹)₂SiOR² or —(R¹)₂Si R³—SiR⁴ₐ(OR²)₃₋ₐ where each R¹ independently represents a monovalent hydrocarbyl group, for example, an alkyl group, in particular having from 1 to 8 carbon atoms, (and is preferably methyl); each R² and R⁴ group is independently an alkyl or alkoxy group in which the alkyl groups suitably have up to 6 carbon atoms; R³ is a divalent hydrocarbon group which contains between 1 and 10 carbon atoms which may be interrupted by one or more siloxane spacers having up to six silicon atoms; and a has the value 0, 1 or 2.

The polymer chain A can for example be a siloxane-containing polymer chain such as an organopolysiloxane or a siloxane/organic block copolymeric molecular chain. Hydroxy-terminated organopolysiloxanes, particularly polydiorganosiloxanes, are widely used in sealants and are suitable for use in the present invention. Thus the polymer (A) preferably includes siloxane units of formula (2):

—(R⁵_{b}SiO_{(4-b)/2})— (2)

in which each R⁵ is independently an organic group such as a hydrocarbon group having from 1 to 18 carbon atoms, a substituted hydrocarbon group having from 1 to 18 carbon atoms or a hydrocarbonoxy group having up to 18 carbon atoms and b has, on average, a value of from 1 to 3

The siloxane polymer can have a viscosity as desired to provide a suitable coating. In embodiments, the siloxane polymer comprises a mixture of two or more siloxanes. The two or more siloxanes can be the same or different in terms of structure of functionality. In one embodiment, the siloxane polymer comprises a mixture of hydroxy terminated polydimethylsiloxane polymers of different molecular weights. In one embodiment, the siloxane polymer comprises a first hydroxy terminated polydimethyl siloxane having a viscosity of from about 500 cps to about 1000 cps, from about 600 cps to about 900 cps, or from about 700 cps to about 800 cps, and a second hydroxy terminated polydimethyl siloxane having a molecular weight of from about 14000 cps to about 20000 cps, from about 15000 cps to about 19000 cps, or from about 15500 cps to about 17500 cps.

The siloxane polymer can be present in an amount of from about 40 wt. % to about 90 wt. %, from about 50 wt. % to about 80 wt. %, from about 60 wt. % to about 75 wt. %, or from about 65 wt. % to about 70 wt. % based on the total weight of the composition. These amounts also include the total amount of siloxane polymer in a composition that comprises two or more siloxane polymers.

Where two or more polysiloxanes are employed, the ratio of the different siloxane polymers can be selected as desired to provide a coating with the desired properties. In one embodiment of a composition employing a mixture of a first hydroxy terminated polydimethyl siloxane having a viscosity of from about 500 cps to about 1000 cps, from about 600 cps to about 900 cps, or from about 700 cps to about 800 cps, and a second hydroxy terminated polydimethyl siloxane having a molecular weight of from about 14000 cps to about 20000 cps, from about 15000 cps to about 19000 cps, or from about 15500 cps to about 17500 cps, the first hydroxy terminated polydimethyl siloxane is present in an amount of from about 20 wt. % to about 60 wt. %, from about 25 wt. % to about 50 wt. %, or from about 30 wt. % to about 40 wt. % based on the total weight of the composition, and the second hydroxy terminated polydimethyl siloxane is present in an amount of from about 20 wt. % to about 60 wt. %, from about 25 wt. % to about 50 wt. %, or from about 30 wt. % to about 40 wt. % based on the total weigh of the composition. A higher concentration of the lower molecular weight polysiloxane may provide a higher elongation at break, and the concentration of the higher molecular weight polysiloxane can be adjusted to tune the tensile strength of the resulting coating.

Viscosity values may be determined using a Brookfield® viscometer using a DV-2 THB RV/MA/HB-3 spindle and all viscosity measurements were taken at 25° C.

Examples of suitable polyorganosiloxanes include, but are not limited to, those available from Dow Corning under the tradename Xiameter. Some particularly suitable examples include Xiameter OHX-4050 and/or OHX-0750 polymers.

Crosslinker

The crosslinker is selected from an alkoxy crosslinker, an oligomeric siloxane, an oxime crosslinker, or a combination of two or more thereof, where the oxime crosslinker does not release methyl ethyl ketoxime as a byproduct when it is broken down. In one embodiment, the oxime crosslinker is other than butyl ketoxamine.

In one embodiment, the crosslinker is selected from a trialkoxy silane. The trialkoxy silane can be an alkyl trialkyl silane, a vinyl trialkyoxy silane, or a combination of two or more thereof. Examples of suitable trialkoxy silanes include, but are not limited to, Vinyltrimethyoxysilane, Vinyltriethyoxysilane, Methyltrimethoxysilane, Methyltriethoxysilane, and combinations thereof.

The oligomeric siloxane as crosslinker is a condensation product of one or more such monomeric silane crosslinkers such as, but not limited to, those trialkoxysilanes described above.

The oligomeric siloxane can be formed, e.g., from the hydrolysis and condensation of one or more equal or different monomeric silane crosslinkers. The oligomeric siloxane contains functional residues stemming from the monomeric silane crosslinker. For example, a first condensation of two tetramethoxysilane molecules results in a dimer that contains six functional residues; the linking is formed from a functional residue of each molecule by condensation. The structure of the oligomers formed can be complicated, three-dimensional compounds. The number of functional residues in the oligomer can vary according to the degree of condensation, the type of condensation and the monomeric silane crosslinkers used but is at least 2, e.g., 4 or more. In one embodiment, the oligomeric siloxane is an oligomer comprising vinyl and methoxy groups. Such oligomeric siloxanes are commercially available, such as, but not limited to, those under the trade names Dynasylan® 1146, Dynasylan® 6490 from the company Evonik Degussa GmbH, Wacker NM25 from Chemie AG, and Nitrochemi LM400 from Nitrochemie Group.

The degree of condensation of the oligomeric siloxane, that is, the number of the monomeric silane crosslinkers condensed with each other, can vary in wide ranges according to the intended use but can be, e.g., in a range of 2 to 200, for example, of 4 to 50. It is understandable that the degree of condensation, for example, in the case of rather high degrees of condensation, is frequently only an average value.

The oxime crosslinker can be selected as desired with the exception that the crosslinker is other than butyl ketoxamine or methyl ethyl ketoxamine. In embodiments, the oxime crosslinker is selected Ethyl-tri s(acetonoximo)silane, Methyl-tris(methylpropylketoximo)silane, Methyltris(ketoximo) silane, Tris(methylpropylketoximo)vinylsilane, Vinylmethoxy-di(acetonooximo)silane, Vinyl-tris(methylpropylketoximo)silane, or a combination of two or more thereof.

The crosslinker is present in an amount of from about 5 wt. % to about 10 wt. %, from about 5.5 wt. % to about 9 wt. %, from about 6 wt. % to about 8.5 wt. %, or from about 7 wt. % to about 8 wt. % based on the total weigh of the composition.

Adhesion Promoter

The adhesion promoter is not particularly limited. Alkoxy silanes, which are preferably substituted with functional groups, are particularly suitable as adhesion promoters. The functional group is an aminopropyl, glycideoxypropyl or mercaptopropyl group, for example. Adhesion promoters with amino functional groups are particularly suitable. In one embodiment, the alkoxy groups of such silanes are a methoxy or ethoxy group. It is also possible to use a mixture of adhesion promoters. Further suitable adhesion promoters are also amino functional alkylsilsesquioxanes such as amino functional methylsilsesquioxanes or amino functional propyl silsesquioxanes, alkoxylated alkene amines, especially ethoxylated and/or propoxylated and/or propoxylated alkene diamine, as well as further, particularly substituted oligomers, polymers and copolymers based upon polyalkylene glycols.

Examples of suitable adhesion promoters include, but are not limited to, 3-aminopropyltrimethoxysilane, 3-aminopropyldimethoxymethylsilane, N-(2-aminoethyl)-3-aminopropyltrimethoxysilane, N-(2-aminoethyl)-3-aminopropyldimethoxymethylsilane, N-(2-aminoethyl)-N′-[3-(trimethoxysilyl)propyl]ethylenediamine N-(n-butyl)-3-aminopropyltrimethoxysilane, N(beta-aminoethyl) gamma-aminopropyltrimethoxy-silane, or analogues of such silanes with ethoxy instead of methoxy groups. Further, N-phenyl-, N-cyclohexyl-or N-alkylaminosilanes, mercaptosilanes, epoxysilanes, (meth)acrylosilanes, anhydridosilanes, carbamatosilanes, alkylsilanes or iminosilanes, oligomeric forms of these silanes, adducts of primary aminosilanes with epoxysilanes or (meth)acrylosilanes or anhydridosilanes, amino-functional alkylsilsesquioxanes, in particular amino-functional methylsilsesquioxane or amino-functional propylsilsesquioxane may be employed. It will be appreciated that the composition may include a combination of two or more adhesion promoters. 3-Aminopropyltrimethoxysilane, 3-aminopropyltriethoxysilane, N-(2-aminoethyl)-3-aminopropyltrimethoxysilane, N-(2-aminoethyl)-3-aminopropyltriethoxysilane, N-(n-butyl)-3-aminopropyltrimethoxysilane, N(beta-aminoethyl) gamma-aminopropyltrimethoxy-silane, 3-glycidoxypropyl-trimethoxysilane, 3-glycidoxypropyltriethoxysilane or 3-ureidopropyl-trimethoxysilane, or oligomeric forms of these silanes, or combinations of two or more thereof, are particularly suitable for the adhesion promoters.

Examples of suitable adhesion promoters include, but are not limited to, those sold under the tradenames Dynasylan® available from Evonik, Andisil® available from AB Specialty Silicones, and Silquest® available from Momentive Performance Materials Inc.

The adhesion promoter is present in an amount of from about 0.1 wt. % to about 5 wt. % from about 0.5 wt. % to about 4 wt. %, from about 1 wt. % to about 3 wt. %, or from about 1.5 wt. % to about 2.5 wt. % based on the total weight of the composition. Combinations of two or more adhesion promoters may be employed.

Catalyst

The catalyst can be selected from any suitable condensation catalyst. These may include condensation catalysts containing metals such as tin, lead, antimony, iron, cadmium, barium, manganese, zinc, chromium, cobalt, nickel, aluminum, gallium or germanium and zirconium. Examples include organic tin metal catalysts such as alkyltin ester compounds such as Dibutyltin dioctoate, Dibutyltin diacetate, Dibutyltin dimaleate, Dibutyltin dilaurate, butyltin 2-ethylhexoate. 2-ethylhexoates of iron, cobalt, manganese, lead and zinc may alternatively be used.

The catalyst may be present in an amount of from about 0.01 wt. % to about 0.1 wt. %, from about 0.02 wt. % to about 0.09 wt. %, from about 0.03 wt. % to about 0.08 wt. %, or from about 0.05 wt. % to about 0.075 wt. % based on the total weight of the composition. When the crosslinker includes a vinyl functional group, a lower concentration of catalyst may be employed to prevent the composition from curing too quickly. In one embodiment, when the crosslinker comprises a vinyl functional group, the catalyst is present in an amount of from about 0.01 wt. % to about 0.02 wt. % based on the total weight of the composition.

Filler

The compositions include a titanium dioxide filler. The titanium dioxide can be present in an amount of from about 0 wt. % to about 10 wt. %, from about 0.1 wt. % to about 10 wt. %, from about 0.5 wt. % to about 8 wt. %, from about 1 wt. % to about 5 wt. %, or from about 2 wt. % to about 4 wt. % based on the total weight of the composition.

The composition may include one or more fillers with which, e.g., rheological properties of the non-cured formulation as well as the mechanical properties and the surface condition of the cured formulation can be influenced. It can be advantageous to use a mixture of different fillers.

Examples for suitable fillers are inorganic or organic fillers such as natural, ground or precipitated calcium carbonates, that are optionally coated with fatty acids, for example, stearic acid, calcined caolines, aluminum oxides, aluminum hydroxides, silicic acids, for example, highly dispersed silicic acids from pyrolysis processes, carbon black, for example, industrially produced carbon black, nepheline syenite, aluminum silicates, magnesium-aluminum silicates, circle rhodium silicates, quartz meal, cristobalite meal, diatomaceous earth, mica, iron oxides, zirconium oxides, gypsum, annaline, barium sulfate, boron carbide, boron nitride, graphite, carbon fibers, zeolites, glass fibers or hollow glass spheres, whose surface is optionally treated with a hydrophobic agent. Exemplary fillers are calcium carbonates, calcined caolines, carbon black, highly dispersed silicic acids and flame-retardant fillers such as hydroxides or hydrates, for example, hydroxides or hydrates of aluminum, for example, aluminum trihydroxide.

The fillers can be present in an amount of from about 0 wt. % to about 20 wt. %, from about 0.1 wt. % to about 15 wt. %, from about 0.5 wt. % to about 12 wt. %, from about 1 wt. % to about 10 wt. %, from about 2 wt. % to about 8 wt. %, or from about 4 wt. % to about 6 wt. %.

In one embodiment, the composition includes a combination of titanium dioxide and calcium carbonate. The total weight of the titanium dioxide and the calcium carbonate can be from about 10 wt. % to about 20 wt. % based on the total weight of the composition. In one embodiment, the composition includes from about 2 wt. % to about 12 wt. % of titanium dioxide and from about 3 wt. % to about 15 wt. % calcium carbonate, from about 4 wt. % to about 10 wt. % of titanium dioxide and from about 5 wt. % to about 12 wt. % calcium carbonate, or from about 6 wt. % to about 8 wt. % of titanium dioxide and from about 7 wt. % to about 10 wt. % of calcium carbonate.

Other Additives

The composition may include other additives as are known in the art. Examples of other additives include, but are not limited to, softeners, inorganic and/or organic fillers, mineral oil, curing accelerators, pigments, adhesion promoters, auxiliary processing agents, rheology modifiers, stabilizers, dyes, inhibitors, heat stabilizers, antistatic agents, flame protection agents, biocides, waxes, flow-control agents, thixotropic agents and other raw materials and additives familiar to the person skilled in the art.

The compositions may be utilized to coat a surface. The coating is provided by delivering the coating composition to a surface and exposing the composition to moisture to cure the coating. Substrates for applying the disclosed coating composition may include, but are not limited to, exterior and/or interior walls, floors, roofs walkways, and vehicle surfaces.

The present technology may be further understood with respect to the following examples.

### Examples

Lab batches were made for many embodiments and formula optimization was achieved for many embodiments as well. Crosslinkers used in many embodiments include oximes (e.g., Ethyl-tris(acetonoximo)silane (“ETAO”), Methyl-tris(methylpropylketoximo)silane (“MTMPKO”), Methyltris(ketoximo) silane (“MTKO”) and an alkoxy (e.g., High Flash Vinyltrimethyoxysilane (“VTMO”)). Work was conducted involving crosslinker types for RTV-1 Silicone (e.g., Oxime (MEKO-releasing), MEKO-free Oxime, Alkoxy). Experimentation with Alkoxy-type crosslinkers (VTO, VTMO, & MTMOS) was also conducted with many embodiments. Optimization of alternate crosslinker formulas from Nitrochemie, Evonik, and Wacker was conducted. Experimentation with MEKO-free Oxime and Alkoxy crosslinkers provided results that included, but were not limited to, Nitrochemie ETAO and MTMPKO that provided improved tensile/elongation, tear and adhesion to difficult substrates, Evonik High Flash VTMO for providing a formula for adhesion to difficult substrates, and Wacker MTKO for providing a formula for Adhesion to difficult substrates.

The coating compositions utilized are shown in Tables 1 and 2.

TABLE 1
Formulation 1

| Description | Weight % |
|---|---|
| Xiameter OHX-0750 Polymer 750CS | 47.88% |
| Xiameter OHX-4050 Polymer 16500CS | 27.71% |
| TiO₂ | 4.43% |
| Nepheline Syenite | 4.16% |
| CaCO₃ | 8.66% |
| Hydrophobic silica | 0.33% |
| Mineral oil | 0.11% |
| Crosslinker (Wacker NM25) | 5.57% |
| Silquest ® 1120 (Adhesion promoter) | 0.83% |
| 1189 adhesion promoter | 0.28% |
| Catalyst | 0.04% |
| Total | 100.00% |

TABLE 2
Formulation 2

| Description | Weight % |
|---|---|
| Xiameter OHX-0750 Polymer 750CS | 26.58% |
| Xiameter OHX-4050 Polymer 16500CS | 43.45% |
| TiO2 | 5.10% |
| Nepheline Syenite | 8.17% |
| CaCO₃ | 8.17% |
| Hydrophobic silica | 0.42% |
| Mineral oil | 0.09% |
| Crosslinker (Nitrochemie LM400) | 6.88% |
| Silquest ®1120 (Adhesion promoter) | 0.88% |
| 1189 adhesion promoter | 0.20% |
| Catalyst | 0.06% |
| Total | 100.00% |

TABLE 3
Formulation 3

| Description | Weight % |
|---|---|
| Xiameter OHX-0750 Polymer 750CS | 42.47% |
| Xiameter OHX-4050 Polymer 16500CS | 22.30% |
| TiO2 | 8.89% |
| Nepheline Syenite | 3.95% |
| CaCo3 | 8.27% |
| Hydrophobic silica | 0.36% |
| Mineral oil | 0.48% |
| Crosslinker | 8.29% |
| 1120 Adhesion promoter | 3.00% |
| 1189 adhesion promoter | 1.98% |
| Catalyst | 0.01% |
| Total | 100.00% |

Tables 4, 5, and 6 include properties of coatings formed from Formulations 1-3. Testing was conducted following the properties and guidelines set out in ASTM D6694.

TABLE 4

| Testing | Requirements | | | |
|---|---|---|---|---|
| ASTM D6694 | ASTM D6694 | Formulation 3 | Formulation 2 | Formulation 1 |
| Initial Percent Elongation | ≥100 | 206 | 200 | 345 |
| (break)% | | | | |
| Initial Tensile Strength (psi) | ≥150 | 195 | 126 | 126 |
| Tear Resistance (lbf/in) | ≥20 | 22 | 21 | 22 |
| Permeance | ≥2.5 | 6.4 | 6.4 | 5.9 |

TABLE 5

| Testing | | | | |
|---|---|---|---|---|
| Wet Adhesion | Requirements | | | |
| ASTM D6694 | ASTM D6694 | Formulation 3 | Formulation 2 | Formulation 1 |
| Aluminum | ≥2.0 | 3.2 | 2.6 | 3.8 |
| Concrete | ≥2.0 | 2.8 | 2.6 | 1.1 |
| EPDM Single- | ≥2.0 | 1.3 | 0.7 | 0.8 |
| Ply | | | | |
| Galvanized Steel | ≥2.0 | 3.3 | 2.2 | 5.4 |
| PP Mod Bit- | ≥2.0 | 0.9 | 1.1 | 1.1 |
| Granule | | | | |
| SBS Mod Bit- | ≥2.0 | 4.1 | 2.8 | 4.0 |
| Granule | | | | |
| PVC Single-Ply | ≥2.0 | 0.0 | 0.0 | 0.0 |
| SPUF | ≥2.0 | 2.7 | 2.7 | 4.3 |

TABLE 6

| Property | Formulation 3 | Formulation 2 | Formulation 1 |
|---|---|---|---|
| Sag (mis) | 16 | 12 | 16 |
| Brookfield (cps) | 17,356 | 14,112 | 7,862 |
| Density (LB/GL) | 9.68 | 9.58 | 9.30 |
| Dry Tack Free Time | 60 minutes | 60 minutes | 60 minutes |

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a thermal management assembly. Modifications may occur to those skilled in the art and to those who may make and use the invention. The disclosed embodiments are merely for illustrative purposes and not intended to limit the scope of the invention or the subject matter set forth in the claims.

A coating is disclosed that provides an alternative to Methyl Ethyl Ketoxime-generating silicone coatings. The compositions comprises an oxime-free silicone coating that is more environmentally safe and safe for the users. MEKO-free silicone coating compositions and methods of making/using such products are also disclosed.

What is claimed is:

1. A coating composition comprising:
a polydimethylsiloxane polymer;
an adhesion promoter;
a crosslinker;
titanium dioxide; and
a catalyst;
wherein the composition does not release methyl ethyl ketoxime as a by product upon curing.

2. The coating composition of claim 1, wherein the crosslinker is selected from an alkoxy crosslinker, an oligomeric siloxane, an oxime crosslinker, or a combination of two or more thereof.

3. The coating composition of claim 2, wherein the crosslinker comprises an oligomeric siloxane comprising vinyl and methoxy groups.

4. The coating composition of claim 2, wherein the crosslinker comprises an oxime crosslinker selected from the group of Ethyl-tris(acetonoximo)silane, Methyl-tris(methylpropylketoximo)silane, Methyltris(ketoximo) silane, Tris(methylpropylketoximo)vinylsilane, Vinylmethoxy-di(acetonooximo)silane, Vinyl-tris(methylpropylketoximo)silane, or a combination of two or more thereof.

5. The coating composition of claim 2, wherein the crosslinker comprises an alkoxy crosslinker selected from the group of Vinyltrimethyoxysilane, Vinyltriethyoxysilane, Methyltrimethoxysilane, Methyltriethoxysilane, or a combination of two or more thereof.

6. The coating composition of claim 1, wherein the crosslinker is present in an amount of from about 5 wt. % to about 10 wt. % based on the total weight of the coating composition.

7. The coating composition of claim 1, wherein the polydimethylsiloxane polymer comprises terminated curable silanol functionality.

8. The coating composition of claim 1, wherein the polydimethylsiloxane polymer comprises a first silanol terminal functional polydimethylsiloxane having a viscosity of from about 500 cps to about 1000 cps, and a second silanol terminal functional polydimethyl siloxane having a viscosity of from about 14000 cps to about 20000 cps.

9. The coating composition of claim 8, wherein the first silanol terminal functional polydimethylsiloxane is present in an amount of from about 20 wt. % to about 60 wt. %, and the second silanol terminal functional polydimethylsiloxane is present in an amount of from about 20 wt. % to about 60 wt. % based on the total weight of the coating composition.

10. The coating composition of claim 1, wherein the adhesion promoter is selected from 3-aminopropyltrimethoxysilane, 3-aminopropyldimethoxymethylsilane, N-(2-aminoethyl)-3-aminopropyltrimethoxysilane, N-(2-aminoethyl)-3-aminopropyldimethoxymethylsilane, N-(2-aminoethyl)-N′-[3-(trimethoxysilyl)propyl]ethylenediamine N-(n-butyl)-3-aminopropyltrimethoxysilane, N(beta-aminoethyl) gamma-aminopropyltrimethoxy-silane, or an analogue of such silanes wherein at least on ethoxy group is present in the place of a methoxy group.

11. The coating composition of claim 1, wherein the adhesion promoter is selected from (i) N-(n-butyl)-3-aminopropyltrimethoxysilane, and N(beta-aminoethyl) gamma-aminopropyltrimethoxy-silane, or (ii) N-(n-butyl)-3-aminopropyltrimethoxysilane, and from 3-aminopropyltrimethoxysilane.

12. The coating composition of claim 1, wherein the adhesion promoter is present in an amount of from about 0.1 wt. % to about 5 wt. % based on the total weight of the coating composition.

13. The coating composition of claim 1, further comprising silicon dioxide.

14. The coating composition of claim 13, wherein the silicon dioxide comprises a hydrophobic silica.

15. The coating composition of claim 1, further comprising calcium carbonate.

16. The coating composition of claim 15, wherein the titanium dioxide is present in an amount of from about 2 wt. % to about 12 wt. %, and the calcium carbonate is present in an amount of from about 5 wt. % to about 12 wt. % based on the total weight of the composition.

17. The coating composition of claim 16, wherein the total amount of titanium dioxide and calcium carbonate combined is from about 10 wt. % to about 20 wt. % based on the total weight of the composition.

18. The coating composition of claim 1, further comprising nepheline syenite.

19. The coating composition of claim 1, further comprising mineral oil.

20. A method of providing a coating in the form of a coating composition comprising:
providing at least a first surface to be coated;
delivering a coating composition to said at least a first surface to be coated,
said coating composition comprising:
a polydimethylsiloxane polymer;
an adhesion promoter;
a crosslinker;
titanium dioxide; and
a catalyst;
wherein the composition does not release methyl ethyl ketoxime as a by product upon curing.

21. The method of providing a coating in the form of a coating composition of claim 20, wherein the crosslinker is selected from an alkoxy crosslinker, an oligomeric siloxane, an oxime crosslinker, or a combination of two or more thereof.

22. The method of providing a coating in the form of a coating composition of claim 21, wherein the crosslinker comprises an oligomeric siloxane comprising vinyl and methoxy groups.

23. The method of providing a coating in the form of a coating composition of claim 21, wherein the crosslinker comprises an oxime crosslinker selected from the group of Ethyl-tris(acetonoximo)silane, Methyl-tris(methylpropylketoximo)silane, Methyltris(ketoximo) silane, Tris(methylpropylketoximo)vinylsilane, Vinylmethoxy-di(acetonooximo)silane, Vinyl-tris(methylpropylketoximo)silane, or a combination of two or more thereof.

24. The method of providing a coating in the form of a coating composition of claim 21, wherein the crosslinker comprises an alkoxy crosslinker selected from the group of Vinyltrimethyoxysilane, Vinyltriethyoxysilane, Methyltrimethoxysilane, Methyltriethoxysilane, or a combination of two or more thereof.

25. The method of providing a coating in the form of a coating composition of claim 20, wherein the crosslinker is present in an amount of from about 5 wt. % to about 10 wt. % based on the total weight of the coating composition.

26. The method of providing a coating in the form of a coating composition of claim 20, wherein the polydimethylsiloxane polymer comprises terminated curable silanol functionality.

27. The method of providing a coating in the form of a coating composition of claim 20, wherein the polydimethylsiloxane polymer comprises a first silanol terminal functional polydimethylsiloxane having a viscosity of from about 500 cps to about 1000 cps, and a second silanol terminal functional polydimethyl siloxane having a viscosity of from about 14000 cps to about 20000 cps.

28. The method of providing a coating in the form of a coating composition of claim 27, wherein the first silanol terminal functional polydimethylsiloxane is present in an amount of from about 20 wt. % to about 60 wt. %, and the second silanol terminal functional polydimethylsiloxane is present in an amount of from about 20 wt. % to about 60 wt. % based on the total weight of the coating composition.

29. The method of providing a coating in the form of a coating composition of claim 20, wherein the adhesion promoter is selected from 3-aminopropyltrimethoxysilane, 3-aminopropyldimethoxymethylsilane, N-(2-aminoethyl)-3-aminopropyltrimethoxysilane, N-(2-aminoethyl)-3-aminopropyldimethoxymethylsilane, N-(2-aminoethyl)-N′-[3-(trimethoxysilyl)propyl]ethylenediamine N-(n-butyl)-3-aminopropyltrimethoxysilane, N(beta-aminoethyl) gamma-aminopropyltrimethoxy-silane, or an analogue of such silanes wherein at least on ethoxy group is present in the place of a methoxy group.

30. The method of providing a coating in the form of a coating composition of claim 20, wherein the adhesion promoter is selected from (i)N-(n-butyl)-3-aminopropyltrimethoxysilane, and N(beta-aminoethyl) gamma-aminopropyltrimethoxy-silane, or (ii)N-(n-butyl)-3-aminopropyltrimethoxysilane, and from 3-aminopropyltrimethoxysilane.

31. The method of providing a coating in the form of a coating composition of claim 20, further comprising silicon dioxide.

32. The method of providing a coating in the form of a coating composition of claim 20, further comprising calcium carbonate.

33. The method of providing a coating in the form of a coating composition of claim 20, further comprising nepheline syenite.

34. The method of providing a coating in the form of a coating composition of claim 20, further comprising nepheline mineral oil.
